(19) United States
(12) Patent Application Publication
(10) Pub. No.: US 2016/0377448 A1
(43) Pub. Date: Dec. 29, 2016

(54) PREDICTING AND ALERTING USER TO NAVIGATION OPTIONS AND PREDICTING USER INTENTIONS

(71) Applicant: GLOBALFOUNDRIES INC., Grand Cayman (KY)

(72) Inventors: Zachary A. Burns, Golden, CO (US); Yuk L. Chan, Rochester, NY (US); Kin K. Choi, Poughkeepsie, NY (US); David J. Flaherty, Poughkeepsie, NY (US)

(21) Appl. No.: 14/753,682

(22) Filed: Jun. 29, 2015

(51) Int. Cl. G01C 21/36; G01C 21/34; G06N 7/00

(52) U.S. Cl. CPC G01C 21/3617; G06N 7/005; G01C 21/3484

(57) ABSTRACT

A computer implemented prediction and alert method automatically executable by a processing unit of a portable computing device. The method includes determining that an event begins from event information of the portable computing device, generating a list of likely event results based on current conditions of the event and historical data, alerting a user to an event result problem for each likely event result in accordance with first and second determinations as the event information indicates that an event decision of the event is upcoming, removing unlikely event results from the list once the event decision is passed and repeating the generating, alerting and removing until only a single event result remains on the list.

### BACKGROUND

The present invention relates to a method and system to predict and alert a user to navigational options and to predict user intentions.

Despite smart phones and global positioning system (GPS) devices being somewhat ubiquitous, the use of such devices in a navigational regime is generally limited to navigation to destinations that are unfamiliar to the user. While making trips that are familiar or often traveled, the user will tend to just navigate by memory and avoid the unneeded complication of manual address entrance. Unfortunately, in neglecting to enter his destination, the user is often unable to take advantage of some of the other features that a smart phone or GPS device would be able to provide. These other features include, but are not limited to, presentations of alternative route selection options due to an accident or slow traffic, indications that his destination is closed for business or has an extended wait time and information related to an availability of parking near the destination.

While certain mundane solutions do exist for these problems, such as the user being able to call his destination in advance to make sure they are open and have no wait time, the user being able to listen to the radio on the way to the destination in hopes that a traffic report will come through and the user's willingness to park in a sub-par location, these all require some sort of overt user action which is what the user was attempting to avoid in the first place by not inputting his destination into the smart phone or GPS device.

As an example, EP 1969313 describes a navigation system in which contextual information such as time of day, general travel patterns and other criteria are used to determine where a person is likely to go and then prompts the user to confirm one of the suggestions. At the time that a user selects a destination from this pre-populated list, the device functions as a normal GPS with all of the features currently possessed by such a device. Unfortunately, this solution is once again a “pull” infrastructure solution much like a normal GPS and it can be assumed that if the user were unwilling to enter a destination in the first place, it's probably no more likely that having a pre-populated list of destinations would cause them to choose a destination.

### SUMMARY

According to one embodiment of the present invention, a computer implemented prediction and alert method automatically executable by a processing unit of a portable computing device. The method includes determining that an event begins from event information of the portable computing device, generating a list of likely event results based on current conditions of the event and historical data, alerting a user to an event result problem for each likely event result in accordance with first and second determinations as the event information indicates that an event decision of the event is upcoming, removing unlikely event results from the list once the event decision is passed and repeating the generating, alerting and removing until only a single event result remains on the list.

According to another embodiment of the present invention, a portable computing device is provided. The portable computing device includes a global positioning system (GPS) unit, an output unit, a processing unit and a storage unit having historical data and executable instructions stored thereon. When executed, the executable instructions cause the processing unit to automatically determine that a trip begins from travel information obtained from the GPS unit, generate a list of likely destinations based on current conditions of the trip and the historical data, control the output unit to alert a user to a destination problem for each likely destination in accordance with first and second determinations as the travel information indicates that a route decision location of the trip is upcoming, remove unlikely destinations from the list once the route decision location is passed and repeat the generating, alerting and removing until only a single likely destination remains on the list.

According to another embodiment of the present invention, a vehicle is provided and includes a motive housing formed to define an interior configured to accommodate at least a user capable of driving the motive housing and a portable computing device mounted or installed within the interior. The portable computing device includes a global positioning system (GPS) unit, an output unit, a processing unit and a storage unit having historical data and executable instructions stored thereon. When executed, the executable instructions cause the processing unit to automatically determine that a trip begins from travel information obtained from the GPS unit, generate a list of likely destinations based on current conditions of the trip and the historical data, control the output unit to alert a user to a destination problem for each likely destination in accordance with first and second determinations as the travel information indicates that a route decision location of the trip is upcoming, remove unlikely destinations from the list once the route decision location is passed and repeat the generating, alerting and removing until only a single likely destination remains on the list.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram illustrating a vehicle with a mobile computing device in accordance with embodiments;

FIG. 2 is a schematic diagram illustrating components of a storage unit of the mobile computing device of FIG. 1;

FIG. 3 is a flow diagram illustrating a computer implemented method of predicting and alerting a user to navigational options in accordance with embodiments;

FIG. 4 is a schematic diagram illustrating components of a first storage unit of the mobile computing device of FIG. 2;

FIG. 5 is a flow diagram illustrating an implementation of embodiments of the computer implemented method of predicting and alerting a user to navigational options of FIG. 3;

FIG. 6 is a flow diagram illustrating additional embodiments of the implementation of FIG. 5;

FIG. 7 is a flow diagram illustrating additional embodiments of the implementation of FIG. 5;

FIG. 8 is a flow diagram illustrating additional embodiments of the implementation of FIG. 5;

FIG. 9 is a diagram illustrating a real-world implementation of the computer implemented method of predicting and alerting a user to navigational options;

FIG. 10 is a diagram illustrating a real-world implementation of the computer implemented method of predicting and alerting a user to navigational options;

FIG. 11 is a diagram illustrating a real-world implementation of the computer implemented method of predicting and alerting a user to navigational options;

FIG. 12 is a diagram illustrating a real-world implementation of the computer implemented method of predicting and alerting a user to navigational options;

FIG. 13 is a diagram illustrating a real-world implementation of the computer implemented method of predicting and alerting a user to navigational options;

FIG. 14 is a diagram illustrating a real-world implementation of the computer implemented method of predicting and alerting a user to navigational options; and

FIG. 15 is a diagram illustrating a real-world implementation of the computer implemented method of predicting and alerting a user to navigational options.

### DETAILED DESCRIPTION

As will be described below, predictive push architecture is provided that allows for pertinent information about a route to be given to the user without the user having to manually enter a destination point. This allows for information that may affect the user's route-choosing decision to be transmitted to the user before the user would normally be able to obtain such information otherwise (i.e., when the user arrives at the actual impediment in force). The predictive push architecture uses a predictive probability algorithm to generate a list of potential destinations for the user at any given moment of the user's trip without a need for a user input destination or verification and an alert threshold that can be configured to provide warnings to the user at a last possible moment during his trip and to eliminate the presentation of unnecessary warnings.

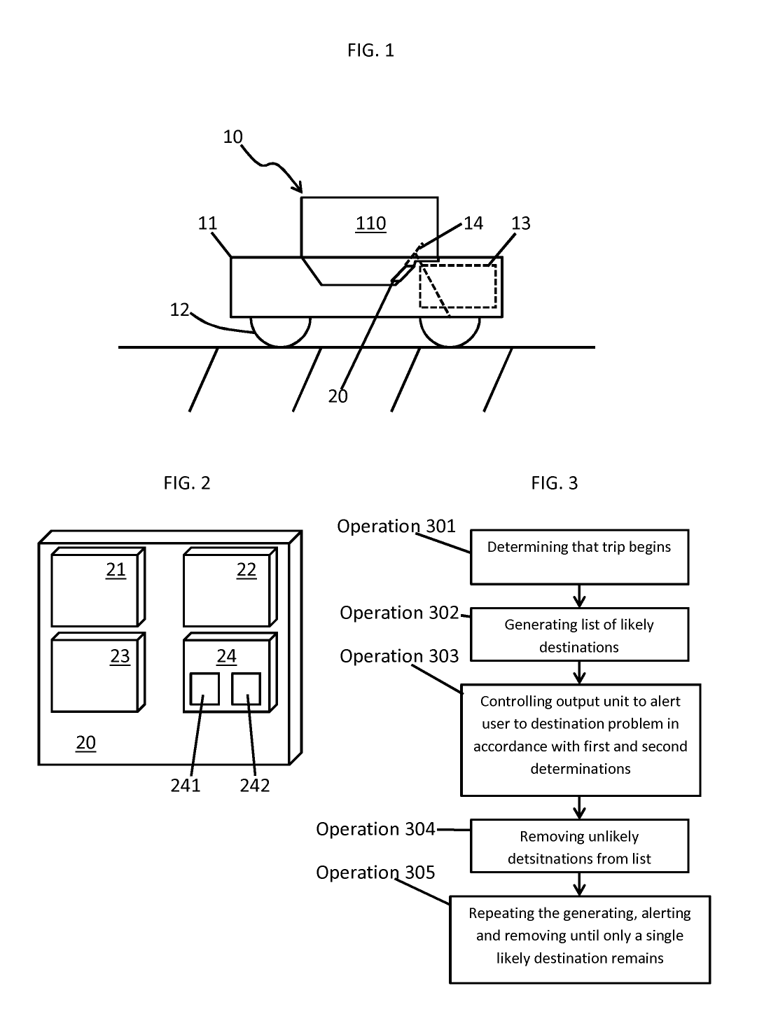

With reference to FIG. 1, a vehicle 10 is provided and, while the vehicle may be configured as a bicycle, a car, a truck or any other suitable form, the following description will relate to embodiments in which the vehicle 10 is a car. The vehicle 10 includes a motive housing 11, wheels 12, an engine 13 and a steering system 14. The motive housing 11 is supported on the wheels 12 and is formed to define an interior 110 that is configured to accommodate at least a user capable of driving and otherwise operating the motive housing 11. The engine 13 is supported within the motive housing 11 to drive rotations of the wheels 12 such that the motive housing 11 is propelled forwardly or reversely. The steering system 14 is operable by the user to direct an orientation of the wheels 12 relative to the motive housing 11 such that the motive housing 11 can be propelled forwardly or reversely in desired directions.

With continued reference to FIG. 1 and with additional reference to FIG. 2, the vehicle 10 further includes a portable computing device 20 that is mounted or installed within the interior 110. The portable computing device 20 may be provided as any one or more of a vehicle mounted or installed navigational system, a vehicle mounted smart phone, a vehicle mounted tablet and a vehicle mounted laptop. In any case, the portable computing device 20 includes a global positioning system (GPS) unit 21, an output unit 22, a processing unit 23 and a storage unit 24.

The GPS unit 21 may be disposed in signal communication with one or both of a satellite-based GPS system and a DVD-based system that can provide the GPS unit 21 with information identifying a current location of the portable computing device 20 and, in some cases, with additional vector information identifying a direction and speed of travel of the portable computing device 20. The output unit 22 may include a display device that can display textual or graphical information to a user, an audio device that can output audible information to the user and a haptic device that can generate haptic outputs (e.g., vibrations) that can be heard and felt by the user. The processing unit 23 may be provided as a central processing or computing unit that is operably coupled to the GPS unit 21, the output unit 22 and the storage unit 24 and thereby disposed to issue operational commands to at least the GPS unit 21 and the output unit 22. The storage unit 24 includes a first storage location 241 having historical user trip data stored thereon and a second storage location 242 having executable instructions stored thereon.

When executed, the executable instructions cause the processing unit 23 to automatically perform a computer implemented prediction and alert method. With reference to FIG. 3, the computer implemented prediction and alert method initially includes determining, by the processing unit 23, that a trip (event) begins from travel (event) information obtained from the GPS unit 21 (operation 301) and generating, by the processing unit 23, a list of likely destinations (event results) based on current conditions of the trip and the historical data in the first storage location 241 (operation 302). The computer implemented prediction and alert method next includes controlling, by the processing unit 23, the output unit 22 to textually, audibly or haptically alert the user to a destination problem (event result problem) for each likely destination in the list in accordance with results of first and second determinations as the travel information obtained from the GPS unit 21 indicates that a route decision location (event decision) of the trip is upcoming (operation 303). The computer implemented prediction and alert method is completed by the processing unit 23 removing unlikely destinations from the list once the route decision location is passed (operation 304) and repeating the generating, alerting and removing of operations 302, 303 and 304 until only a single likely destination remains on the list (operation 305).

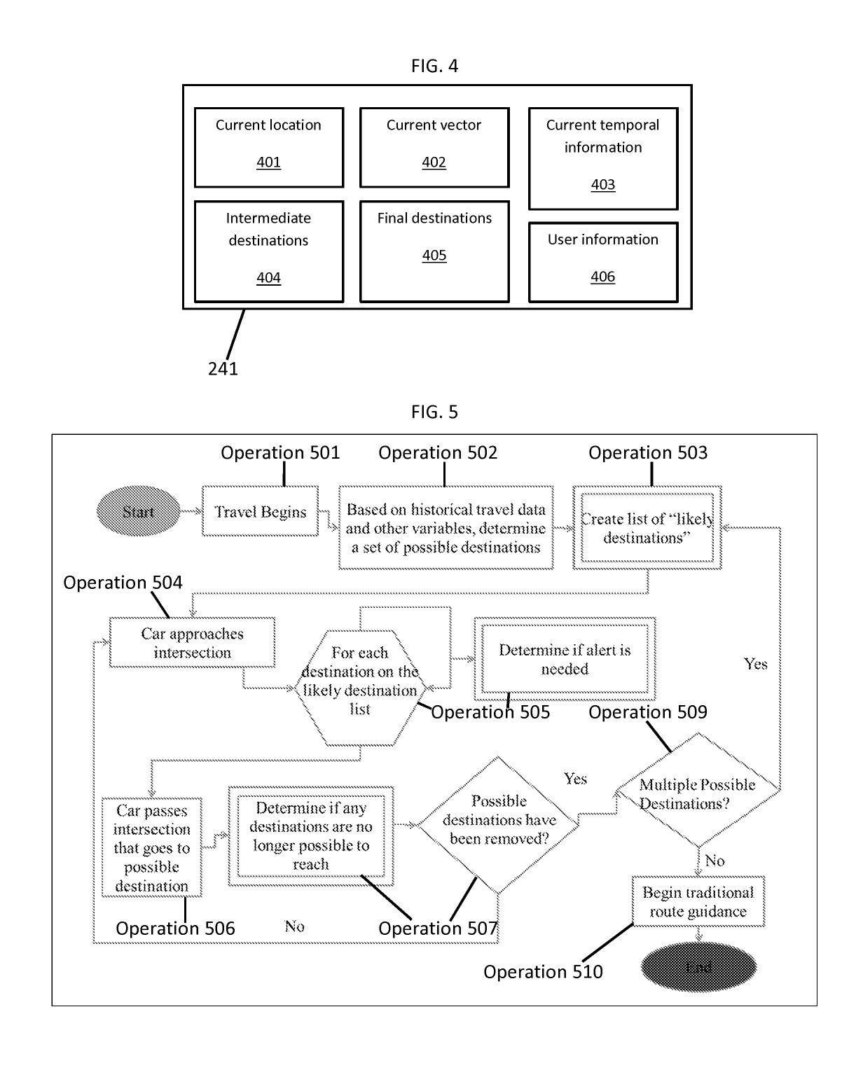

In accordance with embodiments and, with reference to FIG. 4, the current conditions may be stored permanently or temporarily in the first storage location 241 and may include one or more of a current location 401 and a current vector 402 of the portable computing device 20 as well as current temporal information (e.g., a local time, day and date) 403. The historical data may include one or more of previous intermediate destinations 404 and final destinations 405 corresponding to one or both of the current location 401 and current vector 402 as well as the current temporal information 403. In accordance with further embodiments, the generating of the list of the likely destinations of operation 302 may be further based on user information 406 that is mined from external sources such as, but not limited to, traffic news and alerts, on-line information, calendar application data and social media postings. As shown in FIG. 4, the current location 401, the current vector 402, the current temporal information 403, the previous intermediate and final destinations 404 and 405 and the user information 406 may be packetized by the processing unit 23 into a single data packet or into multiple separate data packets.

With reference to FIGS. 5-8, an implementation of embodiments of the computer implemented prediction and alert method of FIG. 3 will now be described. As shown in FIG. 5, operation 301 is executed and indicates that travel begins with the portable computing device 20 in a car or vehicle 10 at operation 501. Then, operations 502 and 503 respectively result in the processing unit 23 determining a set of possible destinations based on historical travel data and other variables (e.g., the current location 401, the current vector 402, etc.) and creating a list of likely destinations. At operation 504, as the travel information indicates that the car approaches an intersection, which represents a route decision location of the trip, operation 302 is executed by the processing unit 23 to textually, audibly or haptically alert the user to a destination problem for each likely destination in the list in accordance with results of first and second determinations at operation 505.

Subsequently, as the travel information indicates that the car passes through and by the intersection at operation 506, operations 304 and 305 are executed by the processing unit 23 such that unlikely destinations are removed from the list by the processing unit at operation 507. Then, the generating, alerting and removing of operations 302, 303 and 304 are repeated at operation 305 until only a single likely destination remains on the list at operation 508. Once only a single likely destination remains on the list, tradition route guidance commences at operations 509 and 510.

In accordance with embodiments and, as shown in FIG. 7, a process whereby the processing unit 23 makes the first and second determinations at operation 505 is illustrated.

The process begins with the processing unit 23 accessing at operation 701 available information relating to problems that may exist with respect to the likely destinations on the list (e.g., that the likely destination is closed if the likely destination is a business) and/or information relating to problems on the route leading to the likely destinations (e.g., that there is traffic caused by an accident on the road leading to the business). The process then continues with the processing unit 23 determining at operation 702 that a destination problem exists at one of the likely destinations in accordance with the available information. In an event that no destination problem exists, the processing unit 23 does not control the output unit 22 to alert the user at operation 703. However, in an event that a destination problem is determined to exist, the processing unit 23 attempts at operation 704 to generate substitute destinations (in the case of the likely destination being a business that is closed, the substitute destinations would be similar businesses close by the closed business) or alternative routes (in the case of traffic impeding a primary route to the likely destination).

At operation 705, the processing unit 23 determines whether substitute destinations exist or whether alternative routes are available. In an event that the processing unit 23 is able to generate suitable substitute destinations or alternative routes, the processing unit 23 determines that the upcoming route decision location is not a last route decision location before the one of the likely destinations and thus does not control the output unit 22 to issue an alert at operation 706. However, at operation 707, in an event that the processing unit 23 is not able to generate suitable substitute destinations or alternative routes, the processing unit 23 determines that the upcoming route decision location is a last route decision location before the one of the likely destinations. In this case, the processing unit 23 controls the output unit 22 to issue the alert because the upcoming route decision location is judged to be the user's last opportunity to avoid the destination problem.

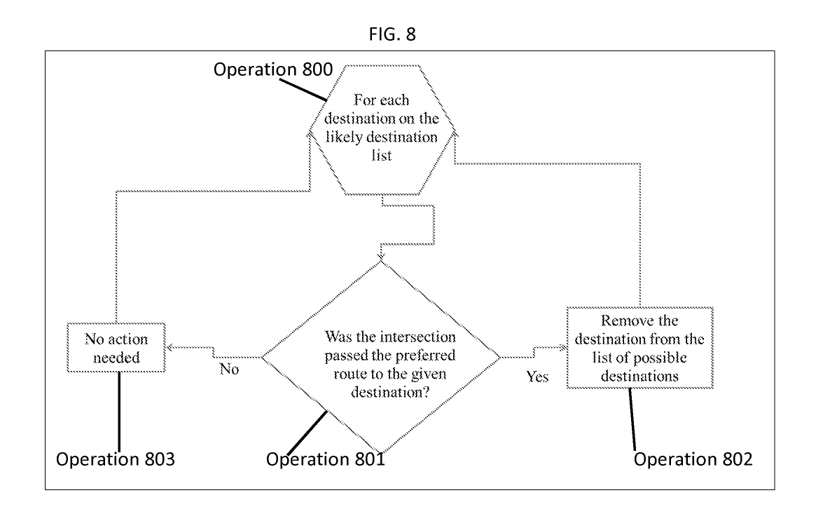

In accordance with embodiments and, as shown in FIG. 8, a process whereby the processing unit 23 removes a likely destination from the list at operation 507 is illustrated.

The process initiates for each likely destination on the list (see operation 800) once the route decision location is passed whereupon the processing unit 23 determines at operation 801 whether any one of the now untaken routes to each likely destination on the list is a preferred or only reasonable route to that destination. If a result of that determination indicates that there is no longer a route to the destination that makes sense (e.g., because it requires an illegal U-turn or substantial out of the way driving), the processing unit 23 removes the destination from the list at operation 802. On the other hand, if reasonable or sensible routes to the destination remain, the processing unit 23 takes no removal action at operation 803.

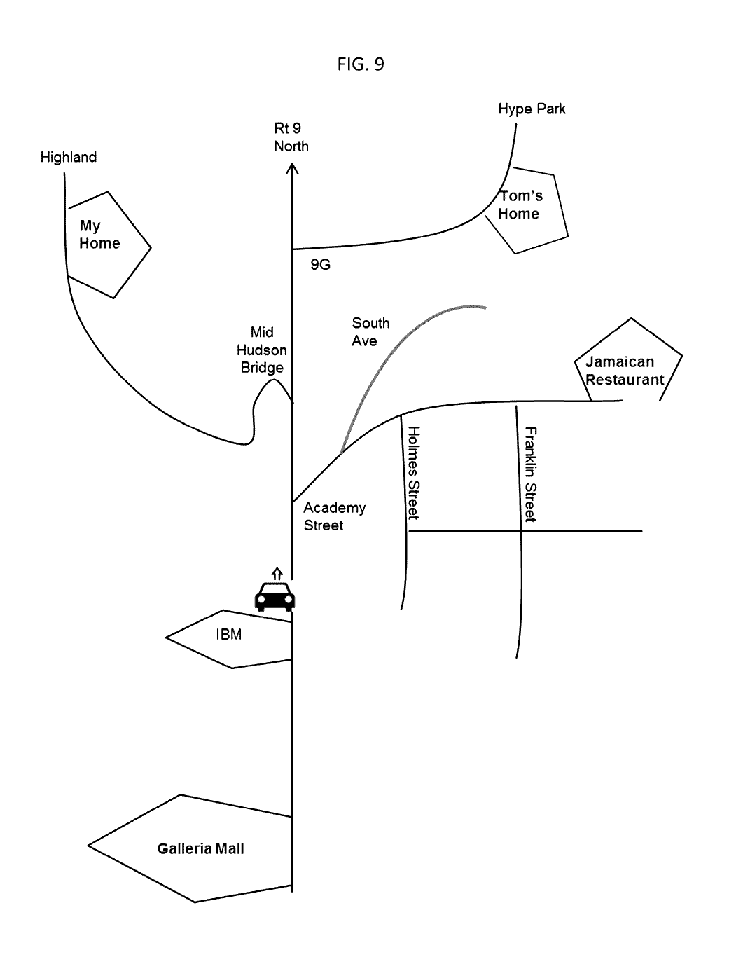

With reference now to FIGS. 9-15, various scenarios are provided to further illustrate the implementation of the above-described embodiments of the computer implemented prediction and alert method of FIG. 3.

As shown in FIG. 9, the current location 401 and the current vector 402 of the portable computing device 20 indicate that Joe is traveling north on Route 9 from IBM. Meanwhile, the previous intermediate destinations 404 and final destinations 405 associated with such a trip indicate that there are 3 typical destinations for Joe: Joe's home, Tom's home and the Jamaican restaurant (the Galleria mall is not a likely destination because Joe is traveling away from the direction of the Galleria mall and would need to make a U-turn on Route 9 to get there).

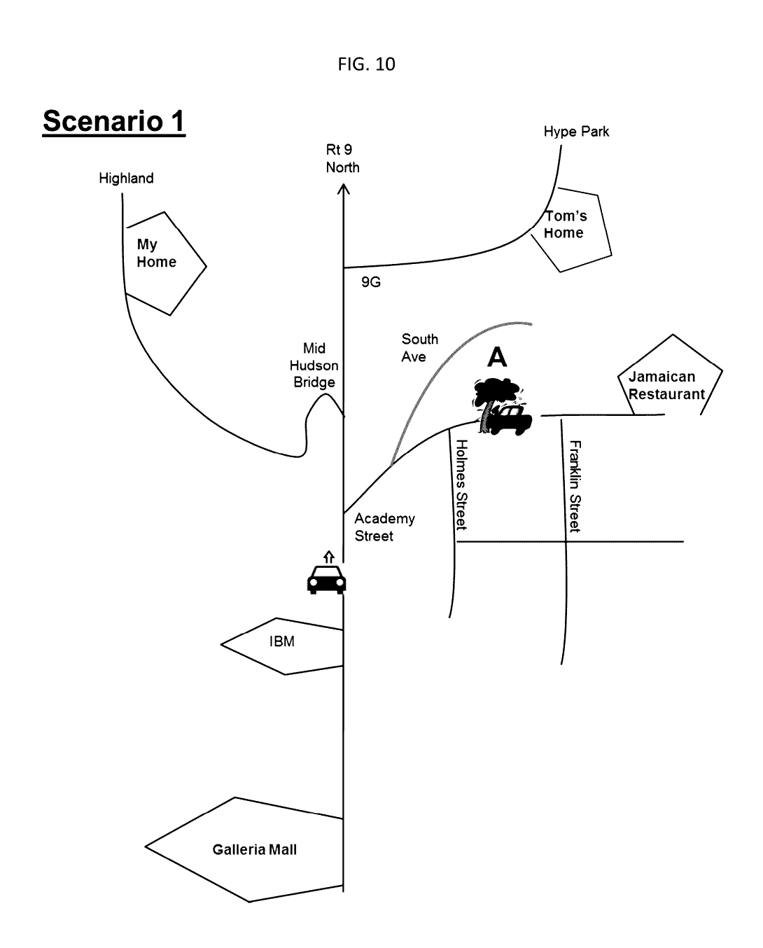

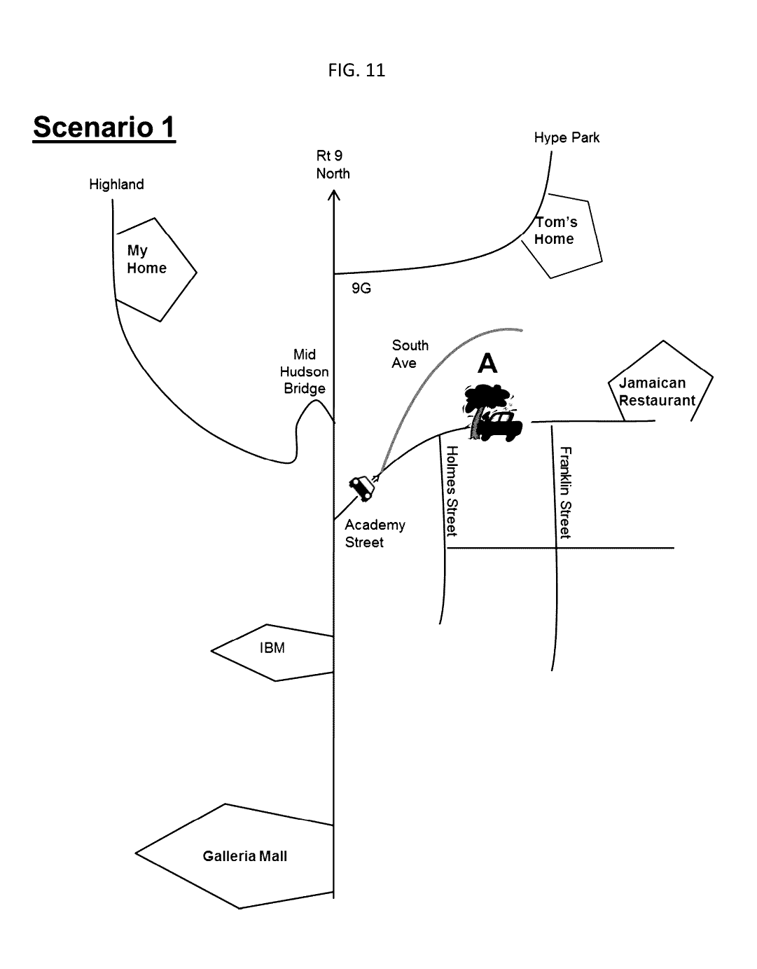

As shown in FIG. 10, an accident occurs on Academy Street before Joe reaches the intersection of Route 9 and Academy Street. Thus, since Joe is still on Route 9 and there are acceptable alternate routes to the Jamaican restaurant that remain available to Joe along Holmes Street, a warning of the accident is not required. Therefore, the processing unit 23 does not control the output unit 22 to issue a warning. Moreover, even if Joe turns onto Academy Street, as shown in FIG. 11, Joe might still turn onto South Avenue before he reaches the intersection between Academy Street and Holmes Street. Thus, since Joe has not yet reached the last intersection before he must make a decision about a route to the Jamaican restaurant, a warning of the accident is not yet required and therefore the processing unit 23 does not control the output unit 22 to issue a warning as yet. This illustrates how the methods described herein limit a number and frequency of warnings and alerts that can be offered to a user.

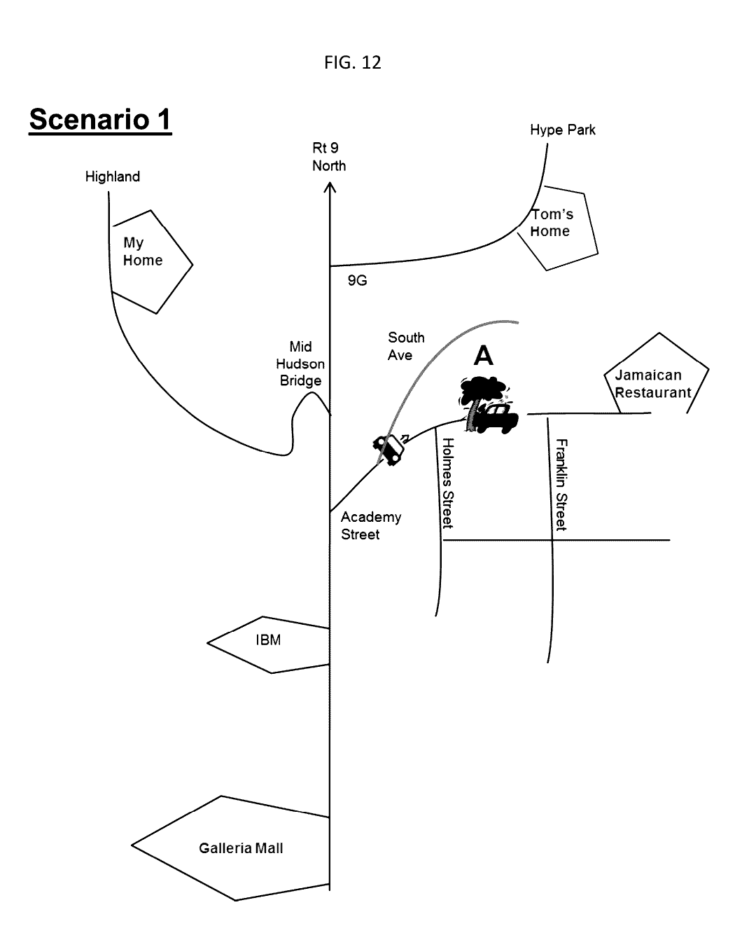

However, as shown in FIG. 12, once Joe passes by the intersection of Academy Street and South Avenue, the next upcoming intersection is the intersection of Academy Street and Holmes Street. Since this intersection is the last route decision location that Joe will reach before getting to the site of the accident on his way to the Jamaican restaurant, a warning of the accident is required and the processing unit 23 accordingly controls the output unit 22 to issue the warning of the accident to Joe.

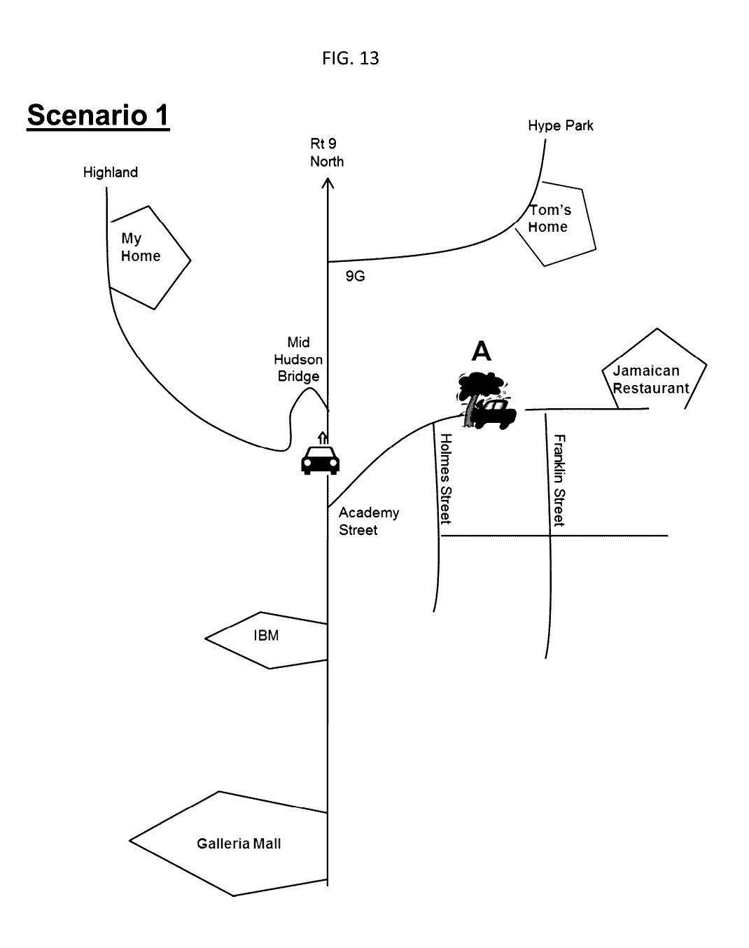

As shown in FIG. 13, Joe subsequently proceeds along Route 9 past the intersection of Route 9 and Academy Street. In so doing, Joe removes the possibility of the Jamaican restaurant being a likely destination and continues driving without ever having been told or warned about the accident on Academy Street. Indeed, given his now apparent intention to drive to Joe's home or Tom's home, such a warning would have represented unneeded and unwanted information (e.g., a false positive) for Joe.

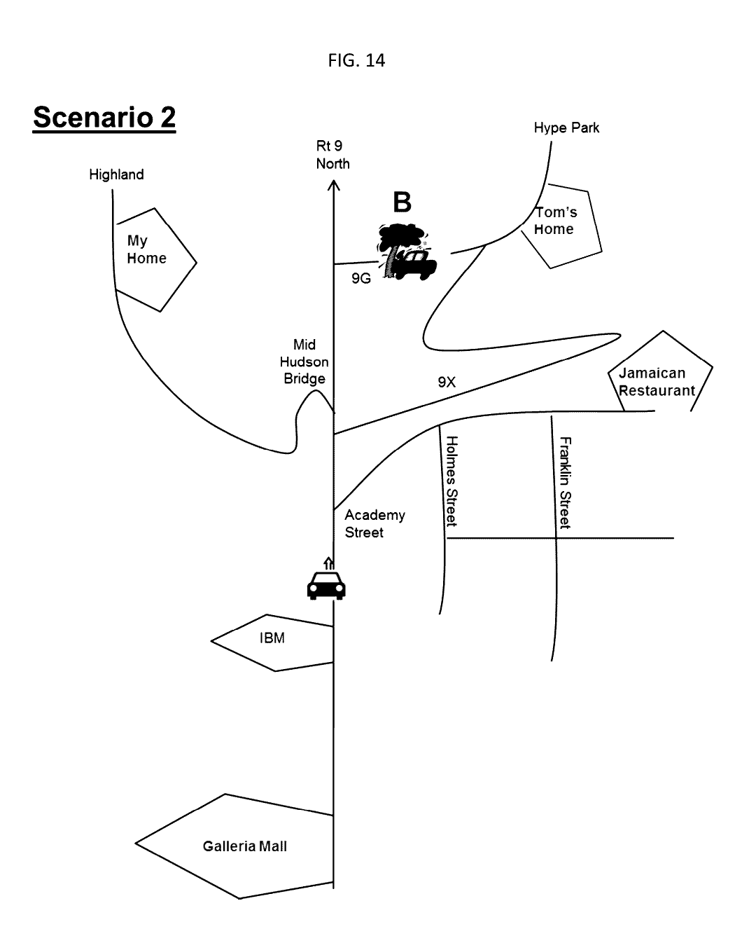

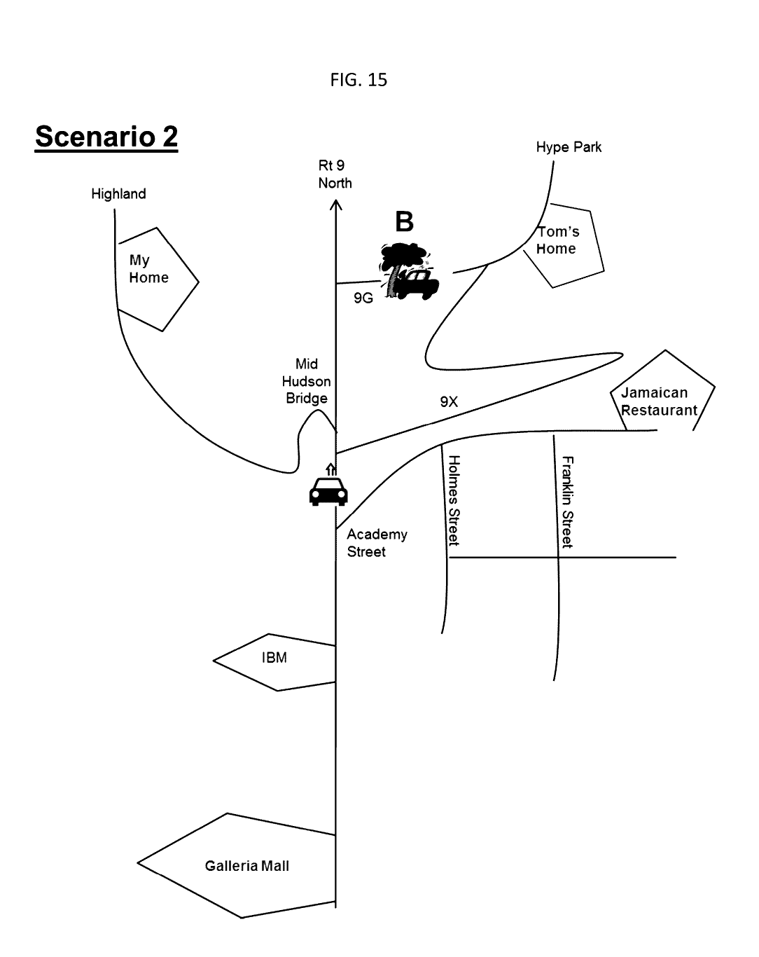

In a second scenario, if as shown in FIG. 14 an accident occurs in Hyde Park prior to Joe reaching the intersection of Route 9 and Academy Street, the processing unit 23 determines that roadway 9X is a reasonable alternative to Tom's home and that no warning is required yet and accordingly does not control the output unit 22 to issue any warning. However, as shown in FIG. 15, once the Joe passes Academy Street, the warning becomes necessary prior to Joe reaching the intersection of Route 9 and roadway 9X. This is due to the fact that, even though Joe might not be going to Tom's home, the alternative route must be decided before Joe reaches the intersection of Route 9 and roadway 9X.

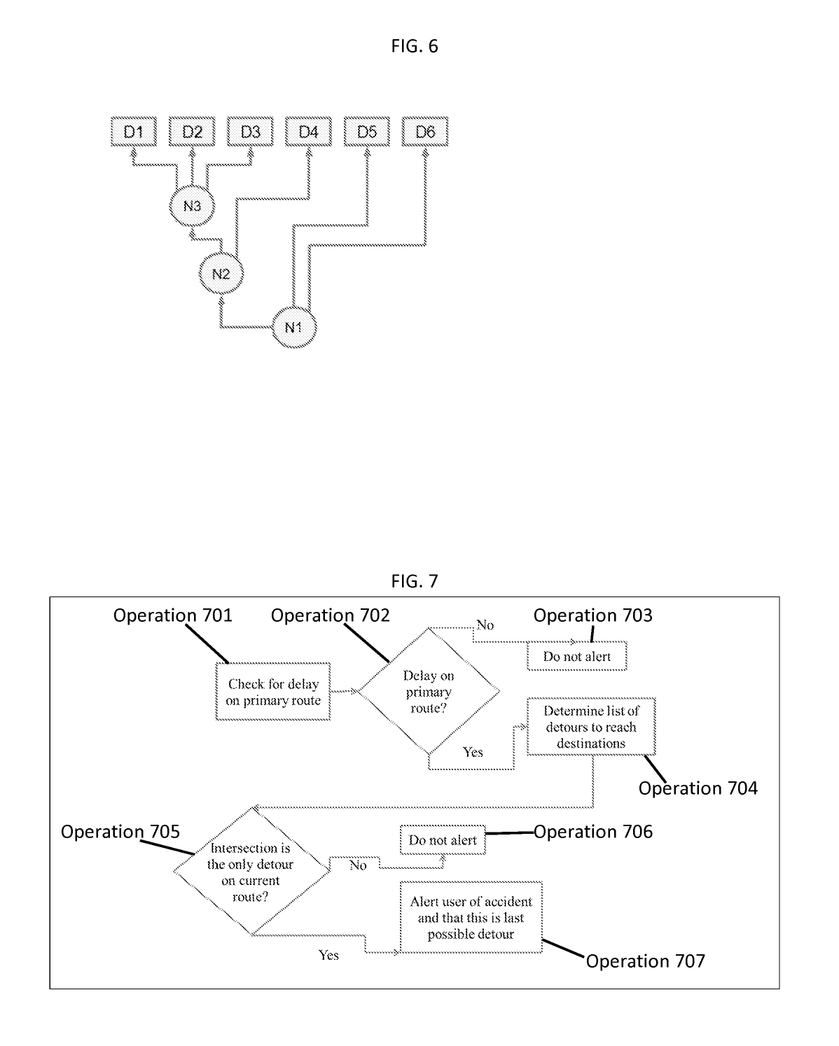

In accordance with embodiments and, as shown in FIG. 6, a process is provided whereby an analytic problem is represented by a network of nodes. This type of analytic problem typically has multiple possible results, and a subset of the results is expected as an answer to the analytic problem. In addition, the solution to an analytic problem is not required immediately after the analytic problem is identified or specified. The time that the solution is required depends on a set of triggers at the trigger node. The method to reach a subset of results could involve multiple criteria made at the decision node. Each of these criteria could be applicable to the multiple results. The nodes in the network could be either a decision node, trigger node or a result. Decision node N2 is applicable to the results D1, D2, D3 and D4. If decision node N2 is invalidated, then result D1, D2, D3 and D4 will not be considered. The decision node and trigger nodes could be independent of each other, the same node or have a linked relationship. In one embodiment, FIG. 6 demonstrates the decision node and trigger node being the same node (i.e., criteria and trigger are evaluated at the same time and, optionally, with a different logic), and some of those nodes have a linked relationship with each other.

The decision nodes and trigger nodes are evaluated periodically. As time elapses, additional information is learned about the analytic problem and could influence both the criteria and triggers at the decision node and trigger node. If the criteria at a decision node determines that one or more results is no longer possible, the criteria, decision nodes and the results will be removed from future consideration. If the trigger at a trigger node determines that the solution to the analytic problem must be revealed, then a subset or the entire list of available results could be revealed. These results will be prioritized. In one embodiment, these results could be prioritized or subsets could be selected using the probabilistic model that is used in existing analytic solutions. For example, any result with more than 80% chance will be shown to the user in a prioritized list based on its probability.

This generalized methodology can be applied to the GPS travel scenarios explained above and in other similar analytic problems. FIG. 6 can be considered as a process whereby the processing unit 23 determines the set of possible destinations at operation 502.

The process begins with a recognition that, as the portable computing device 20 within the vehicle 10 approaches an intersection or navigational decision point N1, the historical travel data and other variables (e.g., the current location 401, the current vector 402, etc.) indicate that 6 likely destinations D1-D6 exist. These likely destinations D1-D6 may be identified by the processing unit 23 as being potential destinations in that they each have a respective actual destination probability that exceeds a predefined threshold in accordance with the current conditions, the historical data and the user information. That is, if the predefined threshold is 10%, each of the likely destinations D1-D6 may be the actual destination of a given trip corresponding to given current conditions, given historical data and given user information 10% of the time or more. Any other historical destinations appearing less than 10% of the time will be ignored. Of course, it is to be understood that the predefined threshold could be set as any percentage and can be modifiable or updateable by the user.

In accordance with embodiments, for each destination, D, P(D) is a probability of the user traveling to destination D and is calculated based on the historical data among other factors. A(D), on the other hand, is a functional description of a need for an alert for each given destination. Thus, A(Dₓ)=Cₓ*P(Dₓ)/(C₁*P(D₁)+(C₂*P(D₂)+ . . . +Cₙ*P(Dₙ)), where Dₙ are all the possible destinations from a given time forward and C_{x, 1, 2, . . . , n} is a constant derived for each destination D.

Once the portable computing device 20 moves beyond intersection or navigational decision point N1 and approaches intersection or navigational decision point N2, likely destinations D5 and D6 are determined to be unlikely destinations as will be described below and are thus removed from the list, which now includes only likely destinations D1-D4. Similarly, once the portable computing device 20 moves beyond intersection or navigational decision point N2 and approaches intersection or navigational decision point N3, likely destination D4 is determined to be an unlikely destination and is thus removed from the list, which now includes only likely destinations D1-D3. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A computer implemented prediction and alert method automatically executable by a processing unit of a portable computing device within a vehicle, the method comprising:
determining, by the processing unit, that the vehicle has begun a trip, the determining being based on travel information obtained from a global positioning system (GPS) unit of the portable computing device;
generating, by the processing unit, a list of likely destinations for the vehicle during the trip based on current conditions of the trip and historical data;
determining, by the processing unit based on information relating to potential destination problems, destination problems that exist for any of the likely destinations on the list, wherein at least one of the destination problems comprises a specific destination problem for a specific one of the likely destinations on the list, the specific one of the likely destinations being a business and the specific destination problem being an indication that the business is closed;
automatically alerting, by an output unit of the portable computing device, a user to the specific destination problem as the travel information indicates that a route decision location of the trip is upcoming and is a last route decision location before the specific one of the likely destinations, the alerting providing the user with an opportunity to avoid the specific destination problem; and
removing, by the processing unit, the specific one of the likely destinations from the list once the route decision location is passed.

2. The method according to claim 1, the portable computing device comprising any one or more of a vehicle installed or mounted navigational system, a smart phone, a tablet and a laptop.

3. The method according to claim 1, the travel information being derived by the global positioning system (GPS) unit and comprising data indicating location, speed and direction of travel of the portable computing device.

4. The method according to claim 1,
the current conditions comprising a current location and vector of the portable computing device and current temporal information,
the historical data comprising previous intermediate and final destinations corresponding to one or both of the current location and vector and the current temporal information, and
the generating of the list of the likely destinations being based on user information mined from external sources.

5. The method according to claim 4, the list of likely destinations comprising potential destinations having respective actual destination probabilities exceeding a predefined threshold in accordance with the current conditions, the historical data and the user information.

6. The method according to claim 1, the destination problems further comprising any routing problems associated with any routes leading to the likely destinations on the list.

7. The method according to claim 1, further comprising removing, by the processing unit from the list, any of the likely destinations from the list that become unlikely destinations during the trip, wherein a particular destination is determined to be an unlikely destination by determining that any one of untaken routes to the particular destination, which is associated with a passed route decision location, is a preferred route.

8. A portable computing device within a vehicle, the portable computing device comprising:
a global positioning system (GPS) unit;
an output unit;
a processing unit; and
a storage unit having historical data and executable instructions stored thereon, wherein, when executed, the executable instructions cause the processing unit to automatically perform a method comprising:
determining that the vehicle has begun a trip based on travel information obtained from the GPS unit,
generating a list of likely destinations of the vehicle during the trip based on current conditions of the trip and the historical data,
determining, based on information relating to potential destination problems, destination problems that exist for any of the likely destinations on the list, wherein at least one of the destination problems comprises a specific destination problem for a specific one of the likely destinations on the list, the specific one of the likely destinations being a business and the specific destination problem being an indication that the business is closed,
controlling the output unit to automatically alert a user to the specific destination problem as the travel information indicates that a route decision location of the trip is upcoming and is a last route decision location before the specific one of the likely destinations, wherein an alert to the specific destination problem before the route decision location provides the user with an opportunity to avoid the specific destination problem, and
removing the specific one of the likely destinations from the list once the route decision location is passed.

9. The portable computing device according to claim 8, the portable computing device comprising any one or more of a vehicle installed or mounted navigational system, a smart phone, a tablet and a laptop.

10. The portable computing device according to claim 8,
the current conditions comprising a current location and vector of the portable device and current temporal information,
the historical data comprising previous intermediate and final destinations corresponding to one or both of the current location and vector and the current temporal information, and
the generating of the list of the likely destinations being based on user information mined from external sources.

11. The portable computing device according to claim 10, the list of likely destinations comprising potential destinations having respective actual destination probabilities exceeding a predefined threshold in accordance with the current conditions, the historical data and the user information.

12. The portable computing device according to claim 8, the destination problems further comprising any routing problems associated with any routes leading to the likely destinations on the list.

13. The portable computing device according to claim 8, further comprising removing any of the likely destinations from the list that become unlikely destinations during the trip, wherein a particular destination is determined to be an unlikely destination by determining that any one of untaken routes to the particular destination, which is associated with a passed route decision location, is a preferred route to the unlikely destination.

14. A vehicle comprising:
a motive housing formed to define an interior configured to accommodate at least a user capable of driving the vehicle, the vehicle comprising an automobile; and
a portable computing device installed within the interior, the portable computing device comprising a global positioning system (GPS) unit, an output unit, a processing unit and a storage unit having historical data and executable instructions stored thereon, wherein, when executed, the executable instructions cause the processing unit to automatically perform a method, the method comprising:
determining that the vehicle has begun a trip based on travel information obtained from the GPS unit,
generating a list of likely destinations of the vehicle during the trip based on current conditions of the trip and the historical data,
determining, based on information relating to potential destination problems, destination problems that exist for any of the likely destinations on the list, wherein at least one of the destination problems comprises a specific destination problem for a specific one of the likely destinations on the list, the specific one of the likely destinations being a business and the specific destination problem being an indication that the business is closed,
controlling the output unit to automatically alert a user to the specific destination problem as the travel information indicates that a route decision location of the trip is upcoming and is a last route decision location before the specific one of the likely destinations, wherein an alert to the specific destination problem before the route decision location provides the user with an opportunity to avoid the specific destination problem, and
removing the specific one of the likely destinations from the list once the route decision location is passed.

15. The vehicle according to claim 14, the portable computing device comprising any one or more of a vehicle installed or mounted navigational system, a smart phone, a tablet and a laptop.

16. The vehicle according to claim 14,
the current conditions comprising a current location and vector of the portable device and current temporal information, and
the historical data comprising previous intermediate and final destinations corresponding to one or both of the current location and vector and the current temporal information.

17. The vehicle according to claim 16, the generating of the list of the likely destinations being based on user information mined from external sources.

18. The vehicle according to claim 17, the list of likely destinations comprising potential destinations having respective actual destination probabilities exceeding a predefined threshold in accordance with the current conditions, the historical data and the user information.

19. The vehicle according to claim 14, the destination problems further comprising any routing problems associated with any routes leading to the likely destinations on the list.

20. The vehicle according to claim 14, further comprising removing of any of the likely destinations from the list that become unlikely destinations during the trip, wherein a particular destination is determined to be an unlikely destination by determining that any one of untaken routes to the unlikely particular destination, which is associated with a passed route decision location, is a preferred route.
